(19) United States
(12) Patent Application Publication
(10) Pub. No.: US 2013/0212662 A1
(43) Pub. Date: Aug. 15, 2013

(54) SECURITY ACCESS IN A COMPUTER-BASED FLOW OF TASKS

(71) Applicants: Stephen Y. Chow, Dallas, TX (US); Grant D. Miller, Superior, CO (US); Nader M. Nassar, Yorktown Heights, NY (US); Richard Newhook, West Chester, PA (US); Erich D. Walls, Valparaiso, IN (US)

(72) Inventors: Stephen Y. Chow, Dallas, TX (US); Grant D. Miller, Superior, CO (US); Nader M. Nassar, Yorktown Heights, NY (US); Richard Newhook, West Chester, PA (US); Erich D. Walls, Valparaiso, IN (US)

(73) Assignee: INTERNATIONAL BUSINESS MACHINES CORPORATION, Armonk, NY (US)

(21) Appl. No.: 13/396,027

(22) Filed: Feb. 14, 2012

(51) Int. Cl. G06F 21/00

(52) U.S. Cl. 726/7

(57) ABSTRACT

Implementing security access includes creating a coordinate system that includes a first axis and a second axis. Points on the first axis and the second axis specify corresponding coordinates. The security access also includes randomly selecting values from a database and populating the coordinate system with the values and selecting a set of the coordinates from the coordinate system. The set of coordinates is indicative of an instruction. The security access further includes generating an image from the coordinate system and the values, the image including labels for the coordinates along respective first axis and second axis, and identifying values corresponding to the set of coordinates. The values correspond to the set of coordinates indicative of an answer to the instruction. The security access also includes transmitting the image and the instruction to a user device, and using the image, the instruction, and the answer as a security access mechanism.

### BACKGROUND

The present invention relates to computer-based security access, and more specifically, to security access in a computer-based flow of tasks using coordinate mapping.

Consumers seeking to implement transactions, such as the purchase of items via electronic commerce (ecommerce) applications that include check out processes oftentimes find themselves at a significant disadvantage over competing interests in these items. For example, it is becoming more commonplace for traders to procure large quantities of popular consumer items for the purpose of resale to these consumers by accessing the ecommerce applications using automated software techniques (e.g., pre-formatted scripts or bots) that place orders for the items. As these software techniques operate at very high speeds, they are able to outpace the capabilities of any interested individuals to procure these items, thereby placing these individuals at a great disadvantage.

Many enterprises have adopted security software tools in an attempt to thwart these automated software systems. One popular technique utilizes visually distorted words or alphanumeric characters that are presented to a user and the user is required to enter them in a special field. The distortion seeks to prevent the automated software systems from identifying the words using character recognition technology, thereby discouraging the automated software practices. However, this type of security can be difficult for the consumer as well, since the distortions sometimes have the effect of preventing recognition of the characters even to a human eye. In addition, individuals who are visually impaired would have a particular disadvantage. Furthermore, anti-security techniques for identifying distorted characters have become more improved over time and are able to achieve greater success rates than ever before.

### SUMMARY

According to one embodiment of the present invention, a method for implementing security access is provided. The method includes creating a coordinate system creating a coordinate system that includes a first axis and a second axis. Points on the first axis and the second axis specify corresponding coordinates. The method also includes randomly selecting values from a database and populating the coordinate system with the values and selecting a set of the coordinates from the coordinate system. The set of coordinates is indicative of an instruction. The method further includes generating an image from the coordinate system and the values, the image including labels for the coordinates along respective first axis and second axis, and identifying values corresponding to the set of coordinates. The values correspond to the set of coordinates indicative of an answer to the instruction. The method also includes transmitting the image and the instruction to a user device, and using the image, the instruction, and the answer as a security access mechanism.

According to another embodiment of the present invention, a system for implementing security access is provided. The system includes a computer processor and a security application executable by the computer processor. The security application implements a method. The method includes creating a coordinate system creating a coordinate system that includes a first axis and a second axis. Points on the first axis and the second axis specify corresponding coordinates. The method also includes randomly selecting values from a database and populating the coordinate system with the values and selecting a set of the coordinates from the coordinate system. The set of coordinates is indicative of an instruction. The method further includes generating an image from the coordinate system and the values, the image including labels for the coordinates along respective first axis and second axis, and identifying values corresponding to the set of coordinates. The values correspond to the set of coordinates indicative of an answer to the instruction. The method also includes transmitting the image and the instruction to a user device, and using the image, the instruction, and the answer as a security access mechanism.

According to a further embodiment of the present invention, a computer program product for implementing security access is provided. The computer program product includes a storage medium having instructions embodied thereon, which when executed by a computer, cause the computer to implement a method. The method includes creating a coordinate system creating a coordinate system that includes a first axis and a second axis. Points on the first axis and the second axis specify corresponding coordinates. The method also includes randomly selecting values from a database and populating the coordinate system with the values and selecting a set of the coordinates from the coordinate system. The set of coordinates is indicative of an instruction. The method further includes generating an image from the coordinate system and the values, the image including labels for the coordinates along respective first axis and second axis, and identifying values corresponding to the set of coordinates. The values correspond to the set of coordinates indicative of an answer to the instruction. The method also includes transmitting the image and the instruction to a user device, and using the image, the instruction, and the answer as a security access mechanism.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which security access using coordinates recognition may be implemented according to an embodiment of the present invention;

FIG. 2 depicts a flow diagram describing a process for implementing security access using coordinates recognition according to an embodiment of the present invention; and

FIG. 3 depicts a user interface screen and sample data provided by the security access system according to an embodiment of the present invention.

### DETAILED DESCRIPTION

According to an exemplary embodiment, computer-based security access processes using coordinates recognition are provided. The security access processes provide validation of an end user system over a network to ensure that responses entered are generated by a human as opposed to an automated software application. In receiving a correct answer to a coordinate recognition challenge, the security access processes presume that the response has been entered by a human.

The security access processes provide a way of discriminating human involvement in a computer-based transaction that utilizes Internet or network-connected interactions that require an endurance of actual human intervention and not a “pseudo intervention” that could be performed by an automated system or application in the realm of computer technology. Cognitive perception and reaction are performed by the human end user to verify that a human is actually interacting with the information technology system and to verify the intentions of the user initiating the transaction.

In addition, the security access processes may be configured to identify methodical queries of a page for access and deny or block that instance from access to the system (e.g., via the incoming IP address, user name, etc.). These, and other features, of the security access processes will now be described.

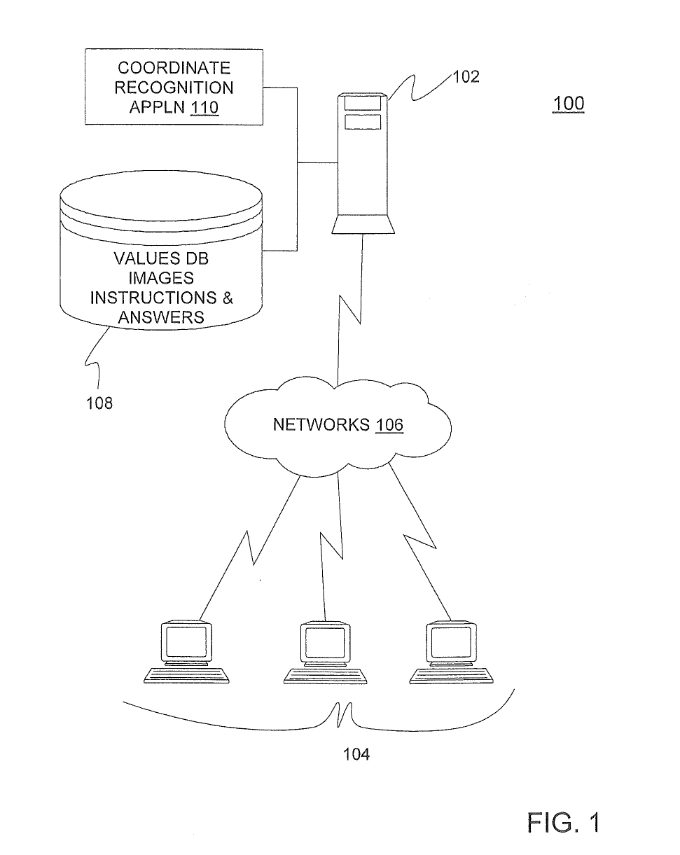

Turning now to FIG. 1, a system upon which the security access processes may be implemented will now be described in an exemplary embodiment. The system 100 of FIG. 1 includes a host system 102 and one or more user systems 104 through which users at one or more geographic locations may contact the host system 102. The host system 102 executes computer instructions for implementing the exemplary security access processes described herein. In one embodiment, the host system 102 represents an enterprise that performs transactions on behalf of users who desire goods or services from the enterprise system. The host system 102 may provide a web site including web pages that offer information regarding goods and/or services, as well as the ability to acquire these goods and services. The host system 102 may be configured to enable transactions between the host system 102 and end users (purchasing items that involve a shopping cart and/or checkout function, accessing personal or confidential information, downloading software, or registering with an entity for access to information or membership functions.

The user systems 104 are coupled to the host system 102 via one or more networks 106. Each user system 104 may be implemented using a general-purpose computer executing a computer program for carrying out processes described herein. For example, the user systems 104 may each implement a web browser application. The user systems 104 may be personal computers (e.g., a lap top, a personal digital assistant) or a network server-attached terminal. In an embodiment, the user systems 104 are operated by consumers of goods or services offered via the host system 102.

The networks 106 may include any type of known networks including, but not limited to, a wide area network (WAN), a local area network (LAN), a global network (e.g. Internet), a virtual private network (VPN), and an intranet. The networks 106 may be implemented using a wireless network or any kind of physical network implementation known in the art. A user system 104 may be coupled to the host system through multiple networks (e.g., intranet and Internet) so that not all user systems 104 are coupled to the host system 102 through the same network. One or more of the user systems 104 and the host system 102 may be connected to the networks 106 in a wireless fashion.

The host system 102 is communicatively coupled to a storage device 108. The storage device 108 stores data relating to the security access processes and may be implemented using a variety of devices for storing electronic information. In an exemplary embodiment, the storage device 108 stores a database of values for random selection by the host system 102, images created for implementing a coordinate recognition challenge, as well as questions (i.e., instructions) and corresponding answers used in providing the security access processes as will be described herein. It is understood that the storage device 108 may be implemented using memory contained in the host system 102 or it may be a separate physical device. The storage device 108 may be logically addressable as a consolidated data source across a distributed environment that includes networks 106. Information stored in the storage device 108 may be retrieved and manipulated via the host system 102.

In an embodiment, the host system 102 operates as a database server and coordinates access to application data including data (e.g., values, images, instructions, and answers) stored on the storage device 108.

The host system 102 depicted in FIG. 1 may be implemented using one or more servers operating in response to a computer program stored in a storage medium accessible by the server. The host system 102 may operate as a network server (e.g., a web server) to communicate with the user systems 104. The host system 102 handles sending and receiving information to and from the user systems 104 and can perform associated tasks.

The host system 102 may also operate as an application server. The host system 102 executes one or more computer programs to implement the security access processes. As shown in FIG. 1, the host system 102 these computer program(s) are implemented by a coordinate recognition application 110.

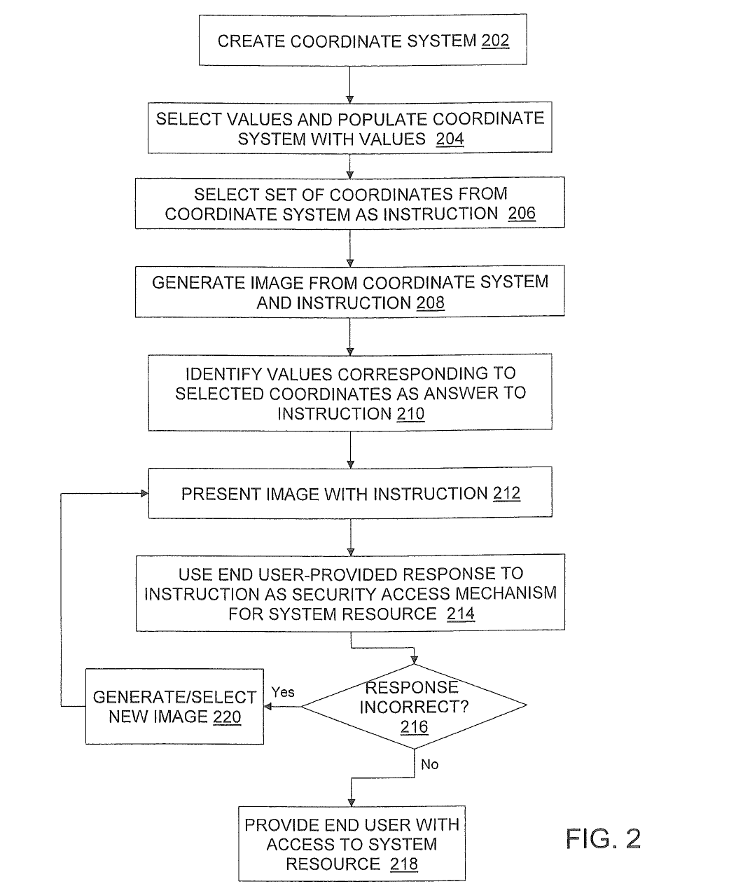

As indicated above, the security access processes provide a cognitive test, which is structured as a coordinate recognition challenge, over a network (e.g., networks 106) to ensure that responses entered are generated by a human as opposed to an automated software application. In receiving a correct answer to the cognitive test, the security access processes presumes that the response has been entered by a human. Turning now to FIG. 2, a process for creating the cognitive test and implementing the security access will now be described in an exemplary embodiment.

The process begins at step 202 whereby the coordinate recognition application 110 creates a coordinate system. The coordinate system may be a two-dimensional array having a first (e.g., ‘x’) axis and a second (e.g., ‘y’) axis. The points in the coordinate system reflect coordinates of the array. Any numeric, alphabetic or symbol found on a standard keyboard or input device may be used as the coordinates labeled along the x and y axes. In one embodiment, the coordinate system is created on demand, e.g., in response to receiving a request from an end user (e.g., via one of the user systems 104) for a resource, such as a web page provided by the host system 102. In an alternative embodiment, the coordinate recognition application 110 may be configured to create a large number of coordinate systems (e.g., thousands) which are used to create a library of images for subsequence retrieval and implementation as will be described further herein.

At step 204, the coordinate recognition application 110 retrieves a number of values from a database stored in the storage device 108, which number corresponds to the number of cells or points in the coordinate system. In an exemplary embodiment, these values are randomly selected by the coordinate recognition application 110 (e.g., via a random generator tool) to ensure each coordinate system is unique. The coordinate recognition application 110 populates these values into cells of the coordinate system.

At step 206, the coordinate recognition application 110 selects a number of coordinates from the coordinate system, which is used as an instruction for a coordinate recognition challenge (e.g., to validate an end user prior to providing access to a resource). In an exemplary embodiment, the coordinates are selected randomly from the coordinate system to ensure each coordinate recognition challenge is unique. The number or set of coordinates selected may be determined by an administrator of the coordinate recognition application 110 (e.g., a representative of the host system 102) or may be pre-configured.

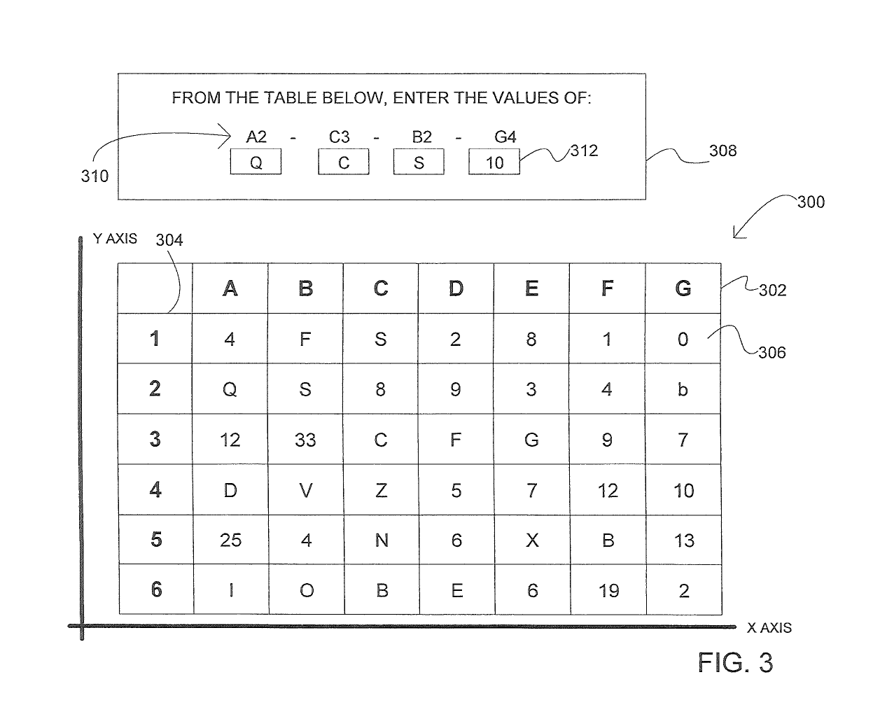

At step 208, the coordinate recognition application 110 generates an image from the coordinate system and the values provided therefore. A sample image is shown generally in a user interface screen 300 of FIG. 3. The image is generated to include labels for the coordinates of the first and second axes, such as A, B, C, D, E . . . , or 1, 2, 3, 4, 5 . . . . In one embodiment, the image may be manipulated by the coordinate recognition application 110, e.g., by rotating the image a specified number of degrees, which may vary at each image generation, or by flipping the image along one or both axes. By manipulating the images, the coordinate recognition application 110 provides an additional layer of security in thwarting the development of anti-security software tools that might store an image repository to identify images in a security system.

At step 210, the values corresponding to the selected set of coordinates is identified by the coordinate recognition application 110. For example, the values are mapped to corresponding points of the coordinate system and identified by the coordinate recognition application 110 from respective coordinate pairs. The values corresponding to the selected set of coordinates indicates the answer to the instruction.

At step 212, the image, along with the instruction is transmitted to the end user (e.g., at one of the user systems 104). As indicated above, the creation of the image may be implemented on demand when the end user requests a resource from the host system 102, or the image may be created along with many other images that are stored in a library in the storage device 108 and selected and transmitted one time, so that no image is used twice. The image may be transmitted over the networks 106 to the user system's 104 browser.

At step 214, the image, along with the instruction and the answer, is used as a security access mechanism to validate end users prior to enabling access to a system resource.

As shown in FIG. 3, the image 300 includes coordinates 302 along an x axis and coordinates 304 along a y axis. Each coordinate pair in the image is associated with a value (e.g., 306). The image 300 is presented to the user system 104 along with an instruction 308, which includes selected coordinates 310 (illustrated as A1, C4, B3, and D5). The instruction may also include text, as well as input fields 312 corresponding to each selected coordinate pair in the instruction. The user is validated when the inputs entered by the user in the input fields 312 match the values in the answer. The coordinate recognition application 110 compares these inputs from the user to the answer stored in the storage device 108 and determines whether the challenge is successful based on the comparisons at step 216. In one embodiment, the coordinate recognition application 110 may be configured to arrange the ordering of the selected coordinates (i.e., the instruction) that is presented to the end user, such that the end user must provide corresponding values in the order arranged by the coordinate recognition application 110. As shown in FIG. 3, e.g., the coordinate recognition application 110 has presented the selected coordinates out of their natural or logical order (i.e., A2-C3-B2-G4).

If the user correctly answers the instruction, the coordinate recognition application 110 provides the end user with access the corresponding system resource at step 218. If, however, the user incorrectly answers the instruction, or refreshes the browser, the coordinate recognition application 110 may be configured to create or select from storage a new image for display at step 220, and the process returns to step 212.

In another embodiment, the security access processes may be configured to account for accessibility issues, such as end users with visual impairments. For example, the security access system may include an audio component configured to communicate with the coordinate recognition application 110. In this embodiment, the coordinate recognition application 110 converts the information from the image and the instruction to an audio file, and presents the audio file (which may be mixed with ambient noise) to the end user. The audio files may be created using tags stored along with the images in the database.

Technical effects of the invention include security access processes that provide validation of an end user system over a network to ensure that responses entered are generated by a human as opposed to an automated software application. In receiving a correct answer to a coordinate recognition challenge, the security access processes presume that the response has been entered by a human. The security access processes provide a way of discriminating human involvement in a computer-based transaction that utilizes Internet or network-connected interactions that require an endurance of actual human intervention and not a “pseudo intervention” that could be performed by an automated system or application in the realm of computer technology. Cognitive perception and reaction are performed by the human end user to verify that a human is actually interacting with the information technology system and to verify the intentions of the user initiating the transaction.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing security access, the method comprising:
creating a coordinate system that includes a first axis and a second axis, wherein points on the first axis and the second axis specify corresponding coordinates;
randomly selecting, via a computer processor, values from a database and populating the coordinate system with the values;
selecting, via the computer processor, a set of the coordinates from the coordinate system, the set of coordinates indicative of an instruction;
generating an image from the coordinate system and the values, the image including labels for the coordinates along respective first axis and second axis;
identifying values corresponding to the set of coordinates, the values corresponding to the set of coordinates indicative of an answer to the instruction;
transmitting the image and the instruction to a user device; and
using the image, the instruction, and the answer as a security access mechanism.

2. The method of claim 1, wherein the coordinate system is created in response to receiving a request from the user device to access a system resource, and transmitting the image and the instruction includes transmitting the image and the instruction to a browser of the user device.

3. The method of claim 1, wherein using the image, the instruction, and the answer as a security access mechanism includes:
receiving a response to the instruction from a user device;
comparing the response to the answer; and
providing access to a system resource when, in response to the comparing, it is determined that the response matches the answer.

4. The method of claim 3, wherein presenting the image and the instruction to a user device further includes randomly selecting an order of a sequence of the coordinates in the instruction and presenting the coordinates in the order derived from random selection.

5. The method of claim 4, wherein providing access to a system resource when it is determined that the response matches the answer further includes providing access only when an order of the values provided in the response matches the values corresponding to the order of the coordinates derived from the random selection.

6. The method of claim 1, further comprising storing the image as a character large object in a storage device prior to presenting the image to the user device.

7. The method of claim 1, wherein generating the image includes manipulating the image before transmitting the image to the user device, the manipulating including at least one of:
rotating the image a predefined number of degrees; and
flipping the image along one of the x axis and the y axis.

8. A system for implementing security access, the system comprising:
a computer processor; and
a security access application executable by the computer processor, the security access application configured to implement a method, the method comprising:
creating a coordinate system that includes a first axis and a second axis, wherein points on the first axis and the second axis specify corresponding coordinates;
randomly selecting values from a database and populating the coordinate system with the values;
selecting a set of the coordinates from the coordinate system, the set of coordinates indicative of an instruction;
generating an image from the coordinate system and the values, the image including labels for the coordinates along respective first axis and second axis;
identifying values corresponding to the set of coordinates, the values corresponding to the set of coordinates indicative of an answer to the instruction;
transmitting the image and the instruction to a user device; and
using the image, the instruction, and the answer as a security access mechanism.

9. The system of claim 8, wherein the coordinate system is created in response to receiving a request from the user device to access a system resource, and transmitting the image and the instruction includes transmitting the image and the instruction to a browser of the user device.

10. The system of claim 8, wherein using the image, the instruction, and the answer as a security access mechanism includes:
receiving a response to the instruction from a user device;
comparing the response to the answer; and
providing access to a system resource when, in response to the comparing, it is determined that the response matches the answer.

11. The system of claim 9, wherein presenting the image and the instruction to a user device further includes randomly selecting an order of a sequence of the coordinates in the instruction and presenting the coordinates in the order derived from random selection.

12. The system of claim 11, wherein providing access to a system resource when it is determined that the response matches the answer further includes providing access only when an order of the values provided in the response matches the values corresponding to the order of the coordinates derived from the random selection.

13. The system of claim 8, wherein the security access application is configured to implement:
storing the image as a character large object in a storage device prior to presenting the image to the user device.

14. A computer program product for implementing security access, the computer program product comprising a storage medium embodied with instructions, which when executed by a computer cause the computer to implement a method, the method comprising:
creating a coordinate system that includes a first axis and a second axis, wherein points on the first axis and the second axis specify corresponding coordinates;
randomly selecting values from a database and populating the coordinate system with the values;
selecting a set of the coordinates from the coordinate system, the set of coordinates indicative of an instruction;
generating an image from the coordinate system and the values, the image including labels for the coordinates along respective first axis and second axis;
identifying values corresponding to the set of coordinates, the values corresponding to the set of coordinates indicative of an answer to the instruction;
transmitting the image and the instruction to a user device; and
using the image, the instruction, and the answer as a security access mechanism.

15. The computer program product of claim 14, wherein the coordinate system is created in response to receiving a request from the user device to access a system resource, and transmitting the image and the instruction includes transmitting the image and the instruction to a browser of the user device.

16. The computer program product of claim 14, wherein using the image, the instruction, and the answer as a security access mechanism includes:
receiving a response to the instruction from a user device;
comparing the response to the answer; and
providing access to a system resource when, in response to the comparing, it is determined that the response matches the answer.

17. The computer program product of claim 16, wherein presenting the image and the instruction to a user device further includes randomly selecting an order of a sequence of the coordinates in the instruction and presenting the coordinates in the order derived from random selection.

18. The computer program product of claim 17, wherein providing access to a system resource when it is determined that the response matches the answer further includes providing access only when an order of the values provided in the response matches the values corresponding to the order of the coordinates derived from the random selection.

19. The computer program product of claim 14, further comprising instructions for causing the computer to implement:
storing the image as a character large object in a storage device prior to presenting the image to the user device.

20. The computer program product of claim 14, wherein generating the image includes manipulating the image before transmitting the image to the user device, the manipulating including at least one of:
rotating the image a predefined number of degrees; and
flipping the image along one of the x axis and the y axis.
